(19) United States
(12) Patent Application Publication
(10) Pub. No.: US 2006/0181139 A1
(43) Pub. Date: Aug. 17, 2006

(54) Wheel nut and cap assembly

(76) Inventors: Martin J. Nilsen, Hampshire, IL (US); Michael E. Ward, Geneva, IL (US); James M. Van Ingen, Algonquin, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/263,804

(22) Filed: Nov. 1, 2005

Related U.S. Application Data
(60) Provisional application No. 60/688,232, filed on Jun. 7, 2005.
(60) Provisional application No. 60/657,356, filed on Feb. 28, 2005.
(60) Provisional application No. 60/653,839, filed on Feb. 17, 2005.

(51) Int. Cl. B60B 7/14

(52) U.S. Cl. 301/37.374

(57) ABSTRACT

A wheel nut and nut cap assembly includes a wheel nut having an outer end with an undercut, and a cap having an inner end received in the undercut. When installed, the inner end of the cap is constrained between the undercut of the wheel nut and a wheel stud extending into the cap.

### CROSS-REFERENCE TO RELATED APPLICATIONS

The present regular United States Patent Application claims the benefits of U.S. Provisional Patent Application Ser. No. 60/688,232 filed Jun. 7, 2005; Ser. No. 60/657,356 filed Feb. 28, 2005 and Ser. No. 60/653,839 filed Feb. 17, 2005.

### FIELD OF THE INVENTION

The present invention relates generally to automobile wheel assemblies; and, more particularly, the invention pertains to wheel nuts for holding wheel rims against wheel hubs and caps for covering the wheel nuts.

### BACKGROUND OF THE INVENTION

Automobile wheels include pneumatic tires sealingly mounted on metal rims. The automobile includes a rotatable hub having threaded studs projecting outwardly from the hub. The wheel rims have holes for receiving the threaded studs, which project through the rim. Wheel nuts, sometimes referred to as lug nuts, threadedly engage the portions of the studs projecting through the rim holes to hold the wheel against the hub. It is known to provide complementary internal and external tapers on the rim and nut respectively, to center the nut relative to the hole in the rim and thereby properly position the wheel relative to the hub, and to hold the wheel tightly against the hub.

It has been known to use wheel covers or hub caps to cover the somewhat aesthetically displeasing appearance of the hub, studs and wheel nuts as well as significant portions of the wheel rim. More recently, the wheel rims have been made of more aesthetically pleasing materials, or coated with such materials, and have been artistically designed to provide both functionality and a pleasing appearance when exposed. However, the functional necessities of the wheel nut and stud are not always conducive to manufacture of materials similar to the rim or to complement or enhance the appearance of the rim. Further, it is known to retrofit automobiles by replacing more utilitarian and aesthetically ordinary rims having wheel covers with new, more visually impressive rims. Again, the wheel studs may not complement the appearance of the retrofitted rims.

It is known to provide caps to cover the exposed portions of wheel nuts. Wheel nut caps have been made of metals and plastics in a variety of colors to provide a more visually appealing appearance that complements or enhances the appearance of rims. It is known to secure the caps to the wheel nuts by a variety of methods and procedures, including welding, crimping and adhesives. It is also known to provide plastic or metal caps that are adapted to be threadedly received by known wheel nuts. However, a problem with known wheel nut cap designs is that vibration and movement during operation of the vehicle can cause the cap to become detached from the wheel nut. Another problem of known wheel nut caps is that the caps are expensive to manufacture and install.

Accordingly, it is desirable to provide wheel nut caps at lower cost than known designs, and nut caps that remain attached securely to the wheel nuts during use of the automobile.

### SUMMARY OF THE INVENTION

The present invention provides a wheel nut and cap assembly in which the nut includes an undercut portion and the cap includes a complementary portion received in the undercut, whereby the portion of the cap is secured between the wheel nut and an external portion of a wheel stud when the nut is engaged upon the stud.

In one aspect thereof, the present invention provides a wheel nut and cap assembly with a wheel nut having an axial opening with an internal thread therein. The thread defines a first internal diameter of the nut. An outer end of the wheel nut has an undercut defining a second internal diameter greater than the first internal diameter. A cap has a side and an end, with an inner segment of the cap being open. The inner segment is configured for and received in the undercut at the outer end of the nut.

In another aspect thereof, the present invention provides a wheel nut and stud threaded assembly with a threaded shank on the stud and a nut having an axial opening with an internal thread therein. The thread of the nut threadedly engages the threaded shank. An outer end of the nut has an undercut radially spaced from the stud. A cap has a side and an end, and an inner segment of the side is disposed in the undercut, between the nut and the stud.

In a still further aspect thereof, the present invention provides a wheel nut and stud threaded assembly with a threaded shank on the stud, and a nut having an axial opening with an internal thread therein. The thread of the nut threadedly engages the threaded shank. An outer end of the nut has an undercut radially spaced from the stud. A cap has a side and an end, and an inner segment of the side is disposed in the undercut between the nut and the stud.

An advantage called the present invention providing a wheel nut and nut cap assembly in which the cap is physically restrained between a portion of the nut and a portion of the wheel stud upon which the nut is threadedly engaged.

Another advantage of the present invention providing an inexpensive wheel nut cap that can be made in a variety of colors and appearances together with logos or indicia on an end thereof.

Still another advantage of the present invention is providing a wheel nut and cap assembly that is easy to use while mounting a wheel on a hub and while demounting the wheel from the hub.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a cross-sectional view of a wheel nut and cap assembly in accordance with the present invention shown installed with a fragment of a wheel and hub;

FIG. 2 is a cross-sectional view of a portion of a wheel nut and cap assembly in accordance with a second embodiment of the present invention;

FIG. 3 is a cross-sectional view similar to that of FIG. 2, but illustrating still another embodiment of the present invention;

FIG. 4 is a view of the wheel nut of FIG. 3, shown in partial cross section; and

FIG. 5 is view in partial cross-sectional view of the wheel nut cap shown in FIG. 3.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

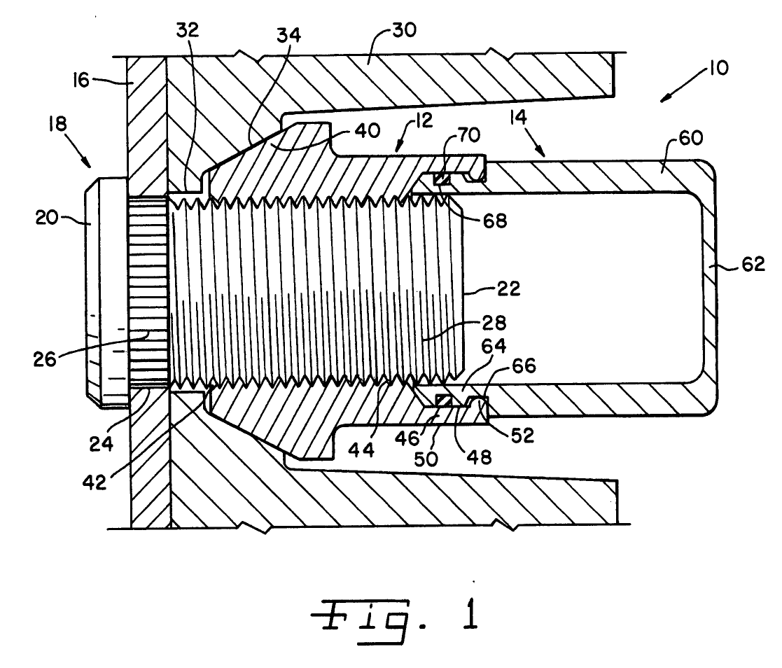

Referring now more specifically to the drawings and to FIG. 1 in particular, a wheel nut cap assembly 10 in accordance with the present invention is shown. Wheel nut and cap assembly 10 includes a wheel nut 12 and a nut cap 14.

Wheel nut cap assembly 10 can be used for securing a wheel on a hub, as those skilled in the art will understand readily. An automobile or the like includes a rotatable hub 16 having a plurality of studs 18 projecting outwardly therefrom. Multiple studs 18 are used in each hub 16; however, only a single stud 18 in a portion of hub 16 is illustrated in FIG. 1. Stud 18 includes a head 20 on the back side of hub 16 and a shank 22 projecting through a hole 24 in hub 16. Knurls 26 adjacent head 20 engage the periphery of hole 24 to secure stud 18 relative to hub 16. Shank 22 includes an exposed helical thread 28 projecting outwardly from the outer side of hub 16 for engaging and forming a threaded assembly with wheel nut 12.

A wheel rim 30 is configured for receiving a tire thereon (not shown). Rim 30 defines a hole 32 for each stud 18 of hub 16, so that all studs 18 project through holes 32 of rim 30. An inwardly tapering bevel 34 is provided in the edge defining hole 32 for receiving nut 12.

Wheel nut 12 includes an inner conical end 40 shaped and sized to be received in bevel 34. An axial opening 42 through wheel nut 12 includes internal threads 44 for engaging thread 28 of stud 18. An outer end 46 includes an internal undercut 48 of greater diameter than opening 42 defining threads 44. An external surface 50 of outer end 46 is configured with flat surfaces for engagement by a wrench to rotate wheel nut 12 on stud 18. Known hex configurations of wheel nuts can be used for outer surface 50. An internally projecting, bead 52 is provided in undercut 48, for mechanically engaging cap 14, as will be described more fully hereinafter. Bead 52 can be a continuous annular formation or one or more discrete segments within undercut 48.

Nut cap 14 includes an annular side 60 and an outer end 62. Side 60 and outer end 62 define an essentially cup-like hollow body having an inner segment 64 configured to be received in undercut 48 of outer end 46 in wheel nut 12. Accordingly, a detent 66, or a plurality thereof is provided for receiving the one or more bead 52 of nut 12. An annular sealant channel 68 may be used together with a sealant 70 to provide a barrier between inner segment 64 of nut cap 14 and outer end 46 of wheel nut 12 to inhibit the intrusion of moisture, dirt and the like. Sealant 70 can be an O-ring or other type of sealant material disposed in sealant channel 68 and against a surface defining undercut 48.

It is anticipated that nut cap assembly 10 is preassembled before installation on stud 18. Accordingly, inner segment 64 of nut cap 14 is aligned with outer end 46 of wheel nut 12, and the two components are pushed toward one another causing inner segment 64 to snap into outer end 46, with bead 52 disposed in detent 66. The snap-fit engagement of bead 52 in detent 66 secures cap 14 to nut 12 for handling as a single assembly when nut 12 is not attached to stud 18, and while installing or removing nut 12 from stud 18.

Threads 44 of wheel nut 12 are of slightly shorter axial extent than the exposed portion of shank 22 of stud 18. Accordingly, as seen in FIG. 1, when wheel nut 12 is tightened along stud 18, urging rim 30 against hub 16, a distal portion of shank 22 projects outwardly beyond nut threads 44. Inner segment 64 of nut cap 14 is thereby captured in undercut 48, between outer end 46 of wheel nut 12 and the outer terminal portion of stud 18. Accordingly, nut cap 14 is securely captured and will not become dislodged easily from wheel nut 12 when the assembly of nut 12 and cap 14 is engaged on stud 18.

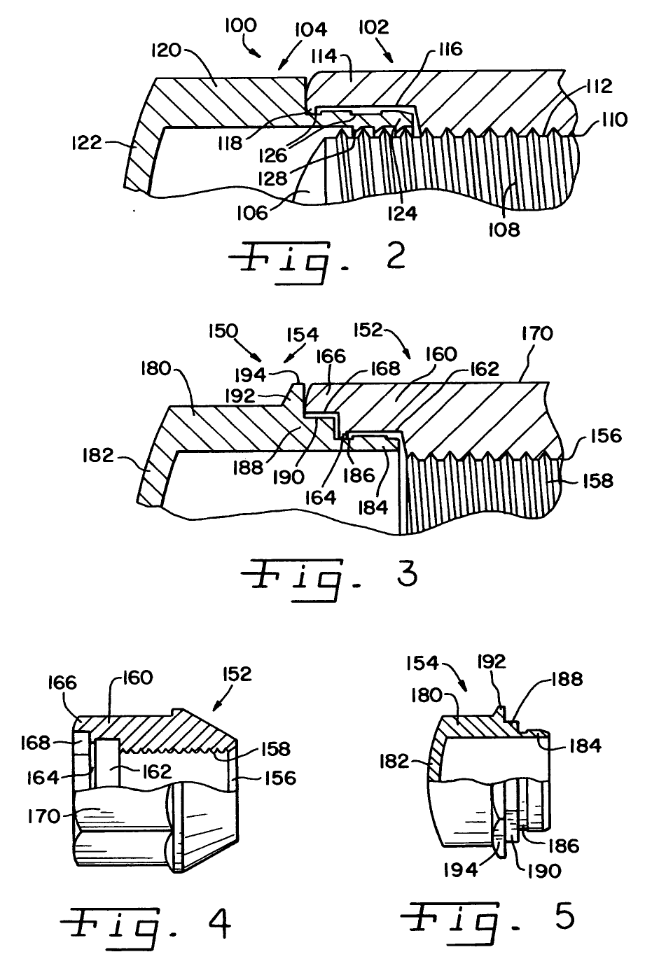

FIG. 2 illustrates another embodiment of the present invention in which a wheel nut and cap assembly 100 includes a wheel nut 102 and a wheel nut cap 104. Assembly 100 is illustrated installed on a stud 106 including a stud thread 108.

Wheel nut 102 defines an axial opening 110 having an internal nut thread 112. An outer end 114 of wheel nut 102 defines an undercut 116 of greater diameter than the diameter of internal thread 112. A bead 118 or a plurality thereof is provided at the outer end of wheel nut 102 and projects inwardly relative to undercut 116.

Wheel nut cap 104 includes a substantially cylindrical side 120 and an outer or exposed end 122. An inner segment 124 of cap 104 is configured to be received in undercut 116. Inner segment 124 defines one or more detents 126, two said detents 126 being illustrated in FIG. 2. Bead 118 is received in one or the other detent 126. Inner segment 124 further defines internal projecting teeth 128 for engaging thread 108 of stud 106. Accordingly, nut cap 104 mechanically engages the terminal portion of thread 108 on stud 106, when assembly 100 is threaded onto stud 106. Inner segment 124 is thereby captured between stud 106 and wheel nut 102, with inner segment 124 mechanically engaging both stud 106 via teeth 128 against thread 108, and nut 102 via detent 126 receiving bead 118.

As illustrated, exemplary nut caps 14, 104 are of slightly narrower diameter than associated nuts 12, 102 such that a wrench can be placed over nut caps 14, 104 to encounter and engage wrench surfaces of wheel nuts 12, 102. Thus, in the embodiments shown in FIGS. 1 and 2 a portion of outer ends 46, 114 are exposed radially outward of nut caps 14, 104. Since nuts 12, 102 may be made of steel, exposing a part thereof may be undesirable relative to the overall appearance presented by the rims, such as rim 30 for which nuts 12, 102 are used.

FIGS. 3-5 illustrate a further embodiment of the present invention in which outermost end surfaces of wheel nuts can be concealed. A wheel nut and cap assembly 150 includes a wheel nut 152 and a wheel nut cap 154. Nut 152 defines an axial opening 156 having an internal thread 158 for engaging a stud (not shown). An outer end 160 defines an undercut 162 and includes an inwardly projecting bead 164. A terminal end 166 defines an internal surface having a hex configuration 168. Outermost surface 170 of nut 152 is of hexagonal or other shape for engagement by a wrench to rotate nut 152 on a stud (not shown)

Nut cap 154 includes a side 180 and an outer end 182. An inner segment 184 is configured to be received in outer end 160 of nut 152 and defines a detent 186 for receiving bead 164 therein. A shoulder area 188 of cap 154 defines an external surface having a hex configuration 190 to be received in internal hex 168. A radial flange 192 of cap 154 provides an external surface 194 of substantially hexagonal or other shape similar to wrench engaging outermost surface 170 of nut 152. Hex surfaces 168 and 170 of nut 152 are configured with respect to each other and with respect to hex surfaces 190 and 194 of cap 154 such that with hex surface 190 engaged within and against hex surface 168 external hex surface 194 aligns with external hex surface 170. Thus, the end of nut 152 is covered and concealed by flange 192 when viewed axially. A wrench used to rotate nut 152 also engages and/or slides over external hex surface 194 of nut cap 154. When installed, inner segment 184 of cap 154 is captured between the outer end of a stud (not shown) and undercut 162 of nut 152.

It should be understood that nut caps 14, 104, 154 described herein can be of a variety of shapes, colors or configurations and made of different materials. Nut caps in accordance with the present invention can be made of metals or plastic and of various colors. Ends 62, 122, 182 can be molded or otherwise configured with various emblems, symbols or the like. The general configuration of sides 60, 120, 180 can be circular or of other shapes, as desired.

The present invention provides a wheel nut and nut cap assembly that can be manufactured inexpensively and assembled easily. The nut cap and nut remain connected one to another before installation on a wheel, and when installed on a wheel the nut cap is physically captured between the wheel stud and the wheel nut. Accordingly, even in the difficult environment of a vibrating, rotating wheel of an automobile, nut caps in accordance with the present invention remain securely connected to the wheel nuts. While shown and described herein for use on an automobile wheel, it should be understood that nuts and nut caps in accordance with the present invention can be used on other assemblies wherein it is desirable to improve the appearance of, or protect a nut installed on a threaded element.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A wheel nut and cap assembly, comprising:
a wheel nut having an axial opening with an internal thread therein, said thread defining a first internal diameter of the nut, and an outer end of said wheel nut having an undercut defining a second internal diameter greater than said first internal diameter; and
a cap having a side and an end, with an inner segment of said cap being open, said inner segment configured for and being received in said undercut at said outer end of said nut.

2. The wheel nut and cap assembly of claim 1, said outer end of said nut defining a bead, and said inner segment of said cap defining an annular detent receiving said bead.

3. The wheel nut and cap assembly of claim 2, said inner segment of said cap defining an annular sealant channel, and a seal disposed in said sealant channel against a surface defining said undercut.

4. The wheel nut and cap assembly of claim 1, said inner segment of said cap defining an annular sealant channel, and a seal disposed in said sealant channel against a surface defining said undercut.

5. The wheel nut and cap assembly of claim 1, said inner segment of said cap having internally projecting teeth.

6. The wheel nut and cap assembly of claim 5, said outer end of said nut defining a bead, and said inner segment of said cap defining an annular detent receiving said bead.

7. The wheel nut and cap assembly of claim 1, said outer end of said wheel nut having a terminal portion defining an internal hex surface, and said cap having an external hex surface received in said terminal portion.

8. The wheel nut and cap assembly of claim 7, said cap including a radial flange covering an end of said nut.

9. The wheel nut and cap assembly of claim 8, said flange having an outer surface defining a hexagon.

10. The wheel nut and cap assembly of claim 9, said outer end of said nut defining a bead, and said inner segment of said cap defining an annular detent receiving said bead.

11. A threaded assembly comprising:
a nut having an axial opening with an internal thread therein, said thread defining a first internal diameter of the nut, and an outer end of said nut having an undercut defining a second internal diameter greater than said first internal diameter; and
a cap having a side and an end, with an inner segment of said cap being open, said inner segment configured for and being received in said undercut at said outer end of said nut;
a threaded shank threadedly engaged with said internal thread of said nut, said threaded shank having a distal portion extending into said cap; and
said inner segment of said cap being constrained between said distal portion of said shank and said undercut of said nut.

12. The threaded assembly of claim 11, said outer end of said nut defining a bead, and said inner segment of said cap defining an annular detent receiving said bead.

13. The threaded assembly of claim 12, said inner segment of said cap defining an annular sealant channel, and a seal disposed in said sealant channel against a surface defining said undercut.

14. The threaded assembly of claim 11, said inner segment of said cap defining an annular sealant channel, and a seal disposed in said sealant channel against a surface defining said undercut.

15. The threaded assembly of claim 11, said inner segment of said cap having internally projecting teeth.

16. The threaded assembly of claim 15, said outer end of said nut defining a bead, and said inner segment of said cap defining an annular detent receiving said bead.

17. The threaded assembly of claim 11, said outer end of said wheel nut having a terminal portion defining an internal hex surface, and said cap having an external hex surface received in said terminal portion.

18. The threaded assembly of claim 17, said cap including a radial flange covering an end of said nut.

19. The threaded assembly of claim 18, said flange having an outer surface defining a hexagon.

20. The threaded assembly of claim 19, said outer end of said nut defining a bead, and said inner segment of said cap defining an annular detent receiving said bead.

21. A wheel nut and stud threaded assembly comprising:
a threaded shank on said stud;
a nut having an axial opening with an internal thread therein, said thread of said nut threadedly engaging said threaded shank;
an outer end of said nut having an undercut radially spaced from said stud; and
a cap having a side and an end, and an inner segment of said side being disposed in said undercut between said nut and said stud.

22. The assembly of claim 21, said outer end of said nut defining a bead, and sad inner segment of said cap defining an annular detent receiving said bead.

23. The assembly of claim 21, said inner segment of said cap defining an annular sealant channel, and a seal disposed in said sealant channel against a surface defining said undercut.

24. The assembly of claim 21, said inner segment of said cap having internally projecting teeth engaging said threaded shank.

25. The assembly of claim 21, said outer end of said wheel nut having a terminal portion defining an internal hex surface, and said cap having an external hex surface received in said terminal portion.

26. The assembly of claim 25, said cap including a radial flange covering an end of said nut.

27. The assembly of claim 26, said flange having an outer surface defining a hexagon
